(19) United States
(12) Patent Application Publication
(10) Pub. No.: US 2016/0283156 A1
(43) Pub. Date: Sep. 29, 2016

(54) KEY-VALUE DRIVE HARDWARE

(71) Applicant: KABUSHIKI KAISHA TOSHIBA, Tokyo (JP)

(72) Inventors: Philip A. KUFELDT, San Jose, CA (US); Abhijeet GOLE, Cupertino, CA (US); Ramanujam THIRUMALAI, Fremont, CA (US); Raghu GURURANGAN, Pleasanton, CA (US)

(21) Appl. No.: 14/666,238

(22) Filed: Mar. 23, 2015

(51) Int. Cl. G06F 3/06; G06F 12/10

(52) U.S. Cl. CPC G06F 3/0626; G06F 12/10; G06F 3/064; G06F 3/0685; G06F 2212/1012; G06F 2212/152; G06F 2212/154; G06F 2212/163; G06F 2212/205; G06F 2212/217; G06F 2212/264

(57) ABSTRACT

A compact storage server is configured with two 2.5-inch form factor disk drives, a solid-state drive, and a processor, all mounted on a support frame that conforms to a 3.5-inch disk drive form factor specification. The 2.5-inch form factor disk drives may be configured as the mass storage devices for the compact storage server, the solid-state drive may be configured to increase performance of the compact storage server, and the processor may be configured to perform object storage server operations, such as responding to requests from clients with respect to storing and retrieving objects.

### BACKGROUND

The use of distributed computing systems, e.g., “cloud computing,” is becoming increasingly common for consumer and enterprise data storage. This so-called “cloud data storage” employs large numbers of networked storage servers that are organized as a unified repository for data, and are configured as banks or arrays of hard disk drives, central processing units, and solid-state drives. Typically, these servers are arranged in high-density configurations to facilitate such large-scale operation. For example, a single cloud data storage system may include thousands or tens of thousands of storage servers installed in stacked or rack-mounted arrays. Consequently, any reduction in the space required for each server can significantly reduce the overall size and operating cost of a cloud data storage system.

### SUMMARY

One or more embodiments provide a compact storage server that may be employed in a cloud data storage system. According to one embodiment, the compact storage server is configured with multiple disk drives, one or more solid-state drives, and a processor, all mounted on a support frame that conforms to a 3.5-inch disk drive form factor specification. The disk drives may be configured as the mass storage devices for the compact storage server, the one or more solid-state drives may be configured to increase performance of the compact storage server, and the processor may be configured to perform object storage server operations, such as responding to requests from clients with respect to storing and retrieving objects.

A data storage device, according to an embodiment, includes a support frame that is entirely contained within a region that conforms to a 3.5-inch form-factor disk drive specification, one or more disk drives mounted on the support frame and entirely contained within the region, one or more solid-state drives entirely contained within the region, and a processor that is entirely contained within the region. The one or more solid-state drives are configured with sufficient storage capacity to store a mapping that associates logical block addresses (LBAs) of the one or more disk drives with a plurality of objects stored on the one or more disk drives. The processor is configured to perform a storage operation based on a mapping stored in the one or more solid-state drives that associates LBAs of the one or more disk drives with a plurality of objects stored on the one or more disk drives.

A data storage system, according to an embodiment, includes multiple data storage devices and a network connected to each of the data storage devices. Each of the data storage devices includes a support frame that is entirely contained within a region that conforms to a 3.5-inch form-factor disk drive specification, one or more disk drives mounted on the support frame and entirely contained within the region, one or more solid-state drives entirely contained within the region, and a processor that is entirely contained within the region. The one or more solid-state drives are configured with sufficient storage capacity to store a mapping that associates logical block addresses (LBAs) of the one or more disk drives with a plurality of objects stored on the one or more disk drives. The processor is configured to perform a storage operation based on a mapping stored in the one or more solid-state drives that associates LBAs of the one or more disk drives with a plurality of objects stored on the one or more disk drives.

A method of storing data, according to an embodiment, is carried out in a data storage system that is connected to a client via a network and includes a server device that conforms to a 3.5-inch form-factor disk drive specification and includes one or more disk drives and one or more solid-state drives. The method includes performing a data storage operation based on a mapping stored in the one or more solid-state drives that associates LBAs of the one or more disk drives with a plurality of objects stored on the one or more disk drives.

### BRIEF DESCRIPTION OF THE DRAWINGS

FIG. 1 is a block diagram of a cloud storage system, configured according to one or more embodiments.

FIG. 2 is a block diagram of a compact storage server, configured according to one or more embodiments.

FIG. 3 schematically illustrates a plan view of the respective footprints of two hard disk drives configured in the compact storage server of FIG. 2, that are superimposed onto a footprint of a support frame for the compact storage server of FIG. 2.

FIG. 4 schematically illustrates a side view of the compact storage server of FIG. 3 taken at section A-A.

FIG. 5 schematically illustrates a plan view of the printed circuit board in FIG. 2, according to one or more embodiments.

FIG. 6 is a block diagram of a compact storage server with a power loss protection circuit, according to one or more embodiments.

FIG. 7 sets forth a flowchart of method steps carried out by a cloud storage system when a client makes a data storage request, according to one or more embodiments.

FIG. 8 sets forth a flowchart of method steps carried out by a cloud storage system when a client makes a data retrieval request, according to one or more embodiments.

### DETAILED DESCRIPTION

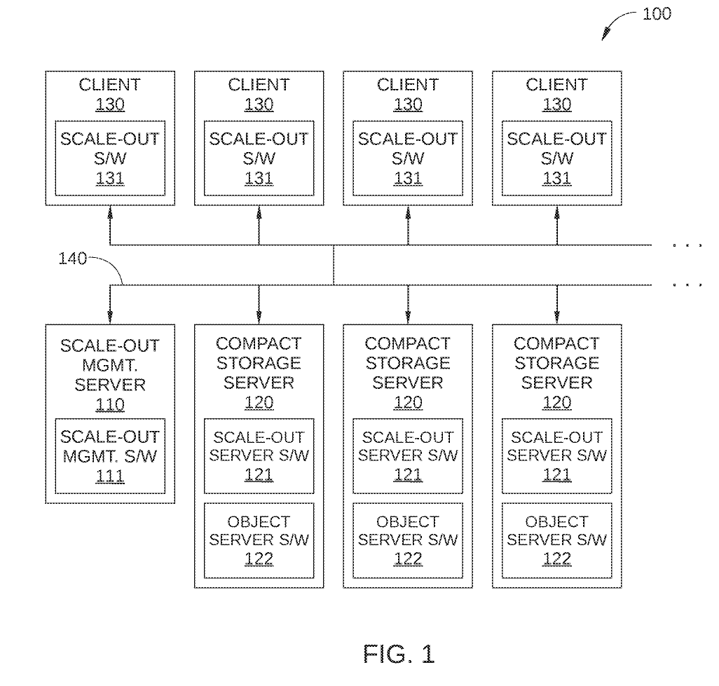

FIG. 1 is a block diagram of a cloud storage system 100, configured according to one or more embodiments. Cloud storage system 100 includes a scale-out management server 110 and a plurality of compact storage servers 120 connected to one or more clients 130 via a network 140. Cloud storage system 100 is configured to implement a hyperscale paradigm for data storage that employs a “scale-out” storage architecture. In a scale-out storage architecture, storage capacity is increased by connecting additional compact storage servers 120 to network 140, rather than replacing a particular storage server with a higher-capacity storage server. Because each additional compact storage server 120 provides additional network capacity and server CPU capacity proportional to the added storage capacity of the server, increases in capacity of cloud storage system 100 generally do not result in the increased data delivery time associated with a scaled-up storage system. Cloud storage system 100 may include a single client 130, such as in the context of enterprise data storage. Alternatively, cloud storage system 100 may include multiple clients 130, e.g., hundreds or even thousands.

Scale-out management server 110 may be any suitably configured server connected to network 140 and configured to perform management tasks associated with cloud storage system 100, such as tasks that are not performed locally by each compact storage server 120. To that end, scale-out management server 110 includes scale-out management software 111 that is configured to perform such tasks. For example, in some embodiments, scale-out management software 111 is configured to monitor scale-out membership of cloud storage system 100, such as detecting when a particular compact storage server 120 is connected to or disconnected from network 140 and therefore is added to or removed from cloud storage system 100. In some embodiments, based on such detected membership changes, scale-out management software 111 is configured to regenerate data placement maps and/or reorganize, e.g., rebalance, data storage between compact storage servers 120.

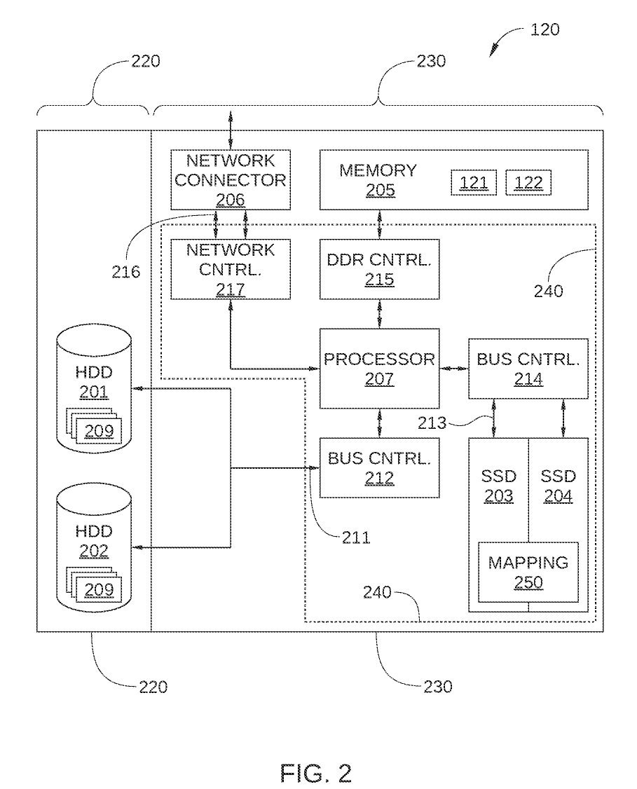

Each compact storage server 120 may be configured to provide data storage capacity as one of a plurality of object servers of cloud storage system 100. Thus, each compact storage server 120 includes one or more mass storage devices, a processor and associated memory, and scale-out server software 121 and object server software 122. One embodiment of a compact storage server 120 is described in greater detail below in conjunction with FIG. 2. It is noted that each compact storage server 120 is connected directly to network 140, and consequently is associated with a unique network IP address, i.e., no other mass storage device connected to the network 140 is associated with this IP address.

Scale-out server software 121, which may also be referred to as a “data storage node,” runs on a processor of compact storage server 120 and is configured to facilitate storage of objects received from clients 130. Specifically, scale-out server software 121 responds to requests from clients 130 and scale-out management server 110, such as PUT/GET/DELETE commands, by performing local or remote operations. For example, in response to a data storage request from a client 130 to store an object (such as a PUT command), scale-out server software 121 may command object server software 122 to store the object locally (i.e., via an internal bus) on a mass storage device of the compact storage server 120 receiving the PUT request. In some embodiments, scale out server software 121 responds to requests from scale out management server 110 to perform management requests, such as data map updates, object rebalancing, and replication restoration. For example, in response to a request from scale-out management software 111 to replicate an object, scale-out server software 121 may store data remotely, i.e., in a different compact storage server 120 of cloud storage system 100, using a PUT command.

Object server software 122 runs on a processor of compact storage server 120 and perform data storage commands, such as read and write commands. Specifically, object server software 122 is configured to implement storage of objects received from scale-out server software 121 on physical locations in the one or more mass storage devices of compact storage server 120, and to implement retrieval of objects stored in the one or more mass storage devices of compact storage server 120. Thus, scale-out server software 121 is essentially a client to object server software 122. For example, object server software 122 may receive a data storage command for an object from scale-out server software 121, where the object includes a set of data and an identifier associated with the set of data, e.g., a key-value pair. Object server software 122 then selects a set of logical block addresses (LBAs) that are associated with an addressable space in a mass storage drive of compact storage server 120, and causes the set of data to be stored in physical locations that correspond to the selected set of LBAs. Similarly, object server software 122 may receive from scale-out server software 121 a data retrieval command for a particular object currently stored in compact storage server 120. Based on an identifier included in the data retrieval command, object server software 122 determines a set of LBAs from which to read data using a mapping stored locally in compact storage server 120, causes data to be read from physical locations in the one or more disk drives that correspond to the determined set of LBAs, and returns the read data to scale-out server software 121.

Each client 130 may be a computing device or other entity that requests data storage services from cloud storage system 100. For example, one or more of clients 130 may be a web-based application or any other technically feasible storage client. Each client 130 also includes scale-out software 131, which is a software or firmware construct configured to facilitate transmission of objects from client 130 to one or more compact storage servers 120 for storage of the object therein. For example, scale-out software 131 may perform PUT, GET, and DELETE operations utilizing object-based scale-out protocol to request that an object be stored on, retrieved from, or removed from one or more of compact storage servers 120.

In some embodiments, scale-out software 131 associated with a particular client 130 is configured to generate a set of attributes or an identifier, such as a key, for each object that the associated client 130 requests to be stored by cloud storage system 100. The size of such an identifier or key may range from 1 to an arbitrarily large numbers of bytes. For example, in some embodiments, the size of a key for a particular object may be between 1 and 4096 bytes, a size range that can ensure uniqueness of the identifier from identifiers generated by other clients 130 of cloud storage system 100. In some embodiments, scale-out software 131 may generate each key or other identifier for an object based on a universally unique identifier (UUID), to prevent two different clients from generating identical identifiers. Furthermore, to facilitate substantially uniform use of the plurality of storage servers 120, scale-out software 131 may generate keys algorithmically for each object to be stored by cloud storage system 100. For example, a range of key values available to scale-out software 131 may be distributed uniformly between a list of compact storage servers 120 that are determined by scale-out management software 111 to be connected to network 140.

Network 140 may be any technically feasible type of communications network that allows data to be exchanged between clients 130, compact storage servers 120, and scale-out management server 110. For example, network 140 may include a wide area network (WAN), a local area network (LAN), a wireless (WiFi) network, and/or the Internet, among others.

As noted above, cloud storage system 100 is configured to facilitate large-scale data storage for a plurality of hosts or users (i.e., clients 130) by employing a scale-out storage architecture that allows additional compact storage servers 120 to be connected to network 140 to increase storage capacity of cloud storage system 100. In addition, cloud storage system 100 may be an object-based storage system, which organizes data into flexible-sized data units of storage called “objects.” These objects generally include a sequence of bytes (data) and a set of attributes or an identifier, such as a key. The key or other identifier facilitates storage, retrieval, and other manipulation of the object by scale-out management software 111, scale-out server software 121, and scale-out software 131. Specifically, the key or identifier allows client 130 to request retrieval of an object without providing information regarding the specific physical storage location or locations of the object in cloud storage system 100 (such as specific logical block addresses in a particular disk drive). This approach simplifies and streamlines data storage in cloud computing, since a client 130 can make data storage requests directly to a particular compact storage server 120 without consulting a large data structure describing the entire addressable space of cloud storage system 100.

FIG. 2 is a block diagram of a compact storage server 120, configured according to one or more embodiments. In the embodiment illustrated in FIG. 2, compact storage server 120 includes two hard disk drives (HDDs) 201 and 202, one or more solid-state drives (SSDs) 203 and 204, a memory 205 and a network connector 206, all connected to a processor 207 as shown. Compact storage server 120 also includes a support frame 220, on which HDD 201, and HDD 202 are mounted, and a printed circuit board (PCB) 230, on which SSDs 203 and 204, memory 205, network connector 206, and processor 207 are mounted. In alternative embodiments, SSDs 203 and 204, memory 205, network connector 206, and processor 207 may be mounted on two or more separate PCBs, rather than the single PCB 230.

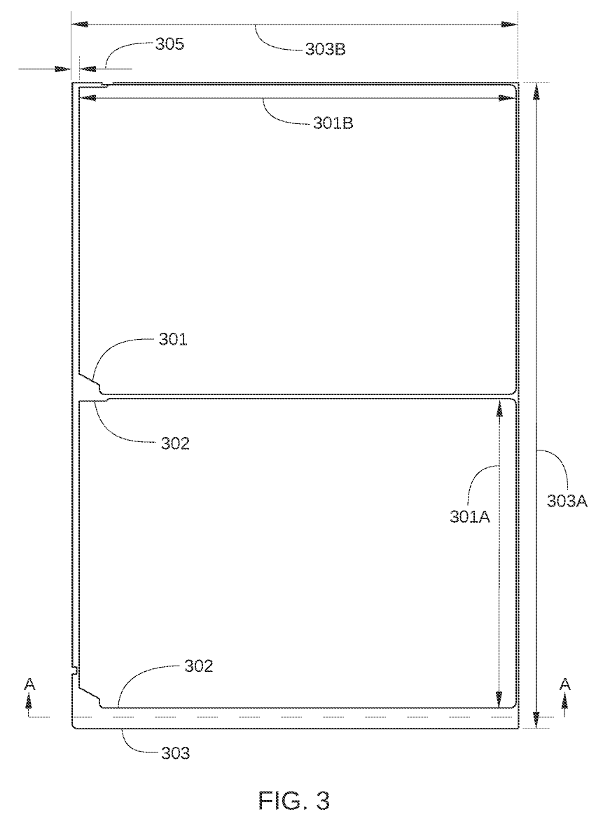

HDDs 201 and 202 are magnetic disk drives that provide storage capacity for cloud storage system 100, storing data (objects 209) when requested by clients 130. HDDs 201 and 202 store objects 209 in physical locations of the magnetic media contained in HDD 201 and 202, i.e., in sectors of HDD 201 and/or 202. In some embodiments, objects 209 include replicated objects from other compact storage servers of 120. HDDs 201 and 202 are connected to processor 207 via bus 211, such as a PCIe bus, and a bus controller 212, such as a PCIe controller. HDDs 201 and 202 are each 2.5-inch form-factor HDDs, and are consequently configured to conform to the 2.5-inch form-factor specification for HDDs (i.e., the so-called SFF-8201 specification). HDDs 201 and 202 are arranged on support frame 220 so that they conform to the 3.5-inch form-factor specification for HDDs (i.e., the so-called SFF-8301 specification), as shown in FIG. 3.

FIG. 3 schematically illustrates a plan view of a footprint 301 of HDD 201 and a footprint 302 of HDD 202 superimposed onto a footprint 303 of support frame 220 in FIG. 2, according to one or more embodiments. In this context, the “footprint” of support frame 220 refers to the total area of support frame 220 visible in plan view and bounded by the outer dimensions of support frame 220, i.e., the area contained within the extents of the outer dimensions of support frame 220. Similarly, footprint 301 indicates the area contained within the extents of the outer dimensions of HDD 201 and footprint 302 indicates the area contained within the extents of the outer dimensions of HDD 202. It is noted that footprint 303 of support frame 220 corresponds to the form factor of a 3.5-inch form factor HDD, and therefore has a length 303A up to about 100.45 mm and a width 303B of up to about 70.1 mm. Footprint 301 of HDD 201 and footprint 302 of HDD 202 each correspond to the form factor of a 2.5-inch form factor HDD and therefore each have a width 301A no greater than about 101.35 mm and a length 301B no greater than about 147.0 mm. Thus, width 303B of support frame 220 can accommodate length 301B of a 2.5-inch form factor HDD and length 303A of support frame 220 can accommodate the width 301A of two 2.5-inch form factor HDDs, as shown.

Returning to FIG. 2, SSD 203 and 204 are each connected to processor 207 via a bus 213, such as a SATA bus, and a bus controller 214, such as a SATA controller. SSDs 203 and 204 are configured to store a mapping 250 that associates each object 209 with a set of LBAs of HDD 201 and/or HDD 202, where each LBA corresponds to a unique physical location in either HDD 201 or HDD 202. Thus, whenever a new object 209 is stored in HDD 201 and/or HDD 202, mapping 250 is updated, for example by object server software 122. Mapping 250 may be partially stored in SSD 203 and partially stored in SSD 204, as shown in FIG. 2. Alternatively, mapping 250 may be stored entirely in SSD 203 or entirely in SSD 204. Because mapping 250 is not stored on HDD 201 or HDD 202, mapping 250 can be updated more quickly and without causing HDD 201 or HDD 202 to interrupt the writing of object data to modify mapping 250.

Because the combined storage capacity of HDD 201 and HDD 202 can be 6 TB or more, mapping 250 occupy a relatively large portion of SSD 203 and/or SSD 204, and SSDs 203 and 204 are sized accordingly. For example, in an embodiment of compact storage server 120 configured for 4 KB objects (i.e., 250 objects per MB), assuming that 8 bytes are needed to map each object plus an additional 16 bytes for a UUID, mapping 250 can have a size of 78 GB or more. In such an embodiment, SSDs 203 and 204 may each be a 240 GB M.2 form-factor SSD, which can be readily accommodated by PCB 230.

In some embodiments, SSDs 203 and 204 are also configured as temporary nonvolatile storage, to enhance performance of compact storage server 120. By initially storing data received from clients 130 to SSD 203 or SSD 204, then writing this data to HDDs 201 or 202 at a later time, compact storage server 120 can more efficiently store such data. For example, while HHD 201 is busy writing data associated with one object, the data for a different object can be received by processor 207, temporarily stored in SSD 203 and/or SSD 204, and then written to HHD 202 as soon as HHD 202 is available. In some embodiments, data for multiple objects are stored in SSD 203 and/or SSD 204 until a target quantity of data has been accumulated in SSD 203 and/or 204, then the data for the multiple objects are stored in HHD 201 or HHD 202 in a single sequential write operation. In this way, more efficient operation of HHD 201 and HHD 202 is realized, since a smaller number of sequential write operations are performed rather than a large number of small write operations, which generally increases latency due to the seek time associated with each write operation. In addition, in some embodiments SSDs 203 and 204 may also be used for journaling (for repairing inconsistencies that occur as the result of an improper shutdown), acting as a cache for HHDs 201 and 202, and other activities that enhance performance of compact storage server 120. In such embodiments, performance of compact storage server 120 is improved by sizing SSDs 203 and 204 to provide approximately 2-4% of the total storage capacity of compact storage server 120 for such activities.

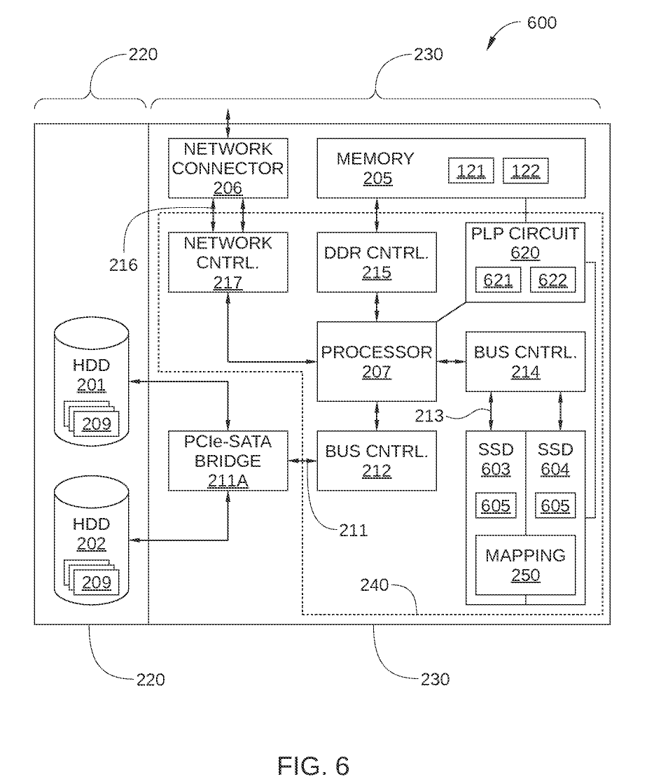

Memory 205 includes one or more solid-state memory devices or chips, such as an array of volatile dynamic random-access memory (DRAM) chips. For example, in some embodiments, memory 205 includes four or more double data rate (DDR) memory chips. In such embodiments, memory 205 is connected to processor 207 via a DDR controller 215. During operation, scale-out software 121 and object server software 122 may reside in memory 205 of FIG. 1. In some embodiments, described below in conjunction with FIG. 6, memory 205 may include a non-volatile RAM section or be comprised entirely of non-volatile RAM.

Network connector 206 enables one or more network cables to be connected to compact storage server 120 and thereby connected to network 140. For example, network connector 206 may be a modified SFF-8482 connector. As shown, network connector 206 is connected to processor 207 via a bus 216, for example one or more serial gigabit media independent interfaces (SGMII), and a network controller 217, such as an Ethernet controller, which controls network communications from and to compact storage server 120.

Processor 207 may be any suitable processor implemented as a single core or multi-core central processing unit (CPU), a graphics processing unit (GPU), an application-specific integrated circuit (ASIC), a field programmable gate array (FPGA), or another type of processing unit. Processor 207 is configured to execute program instructions associated with the operation of compact storage server 120 as an object server of cloud storage system 100. Processor 207 is also configured to receive data from and transmit data to clients 130.

In some embodiments, processor 207 and one or more other elements of compact storage server 120 may be formed as a single chip, such as a system-on-chip (SOC) 240. In the embodiment illustrated in FIG. 2, SOC 240 includes bus controller 212, bus controller 214, DDR controller 215, and network controller 217.

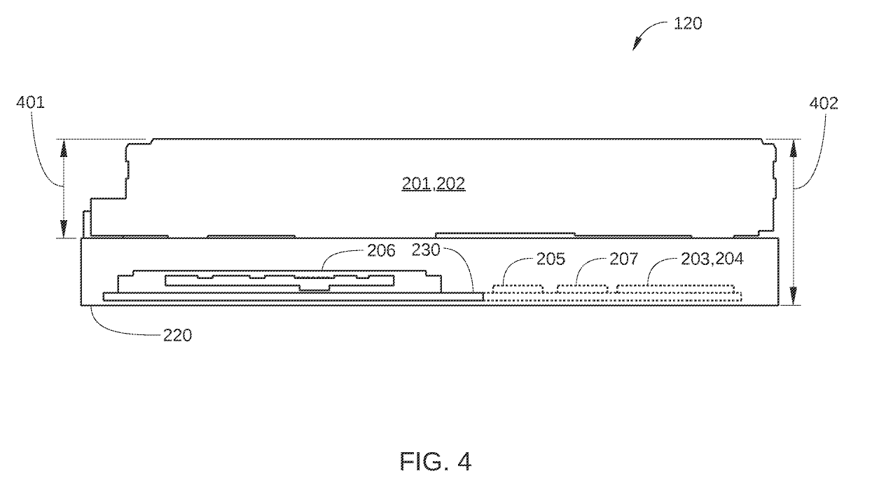

FIG. 4 schematically illustrates a side view of compact storage server 120 taken at section A-A in FIG. 3. As shown in FIG. 3, HDD 201 and 202 are mounted on support frame 220. Because thickness 401 of HDDs 201 and 202 (according to SFF-8201) is approximately either 17 or 19 mm, and because thickness 402 of compact storage server 120 (according to SFF-8301) is approximately 26 mm, PCB 230 can be connected to and mounted below support frame 220 and HDDs 201 and 202. For example, in one embodiment, PCB 230 is oriented parallel to a plane defined by HDDs 201 and 202. Thus, PCB-mounted components of compact storage server 120, e.g., SSDs 203 and 204, memory 205, network connector 206, and/or processor 207, can be disposed under HDD 201 and HDD 202 as shown in FIG. 4. In FIG. 4, PCB 230 is only partially visible and is partially covered by support frame 220, and SSDs 203 and 204, memory 205, and processor 207 are completely covered by support frame 220.

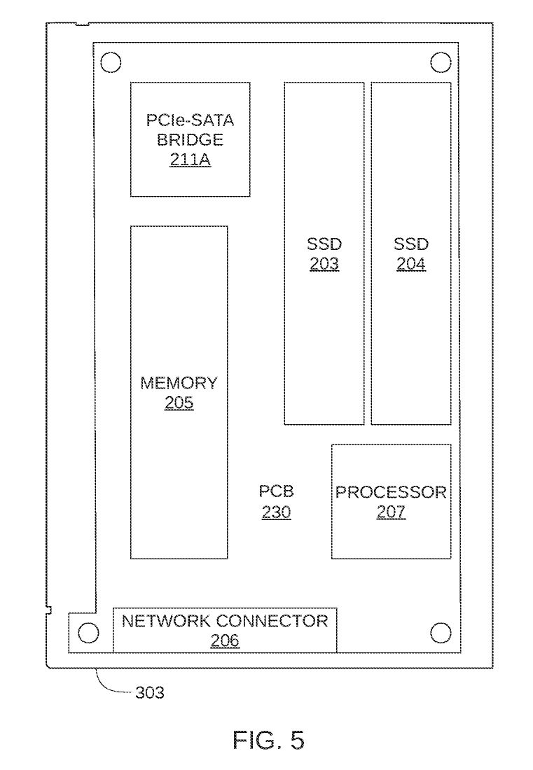

FIG. 5 schematically illustrates a plan view of PCB 230, according to one or more embodiments. As shown, various PCB-mounted components of compact storage server 120 are connected to PCB 230, including SSDs 203 and 204, memory 205, network connector 206, and either SOC 240 or processor 207. Although not illustrated in FIG. 5, portions of bus 211, bus 213, and bus 216 may also be formed on PCB 230.

FIG. 6 is a block diagram of a compact storage server 600 with a power loss protection (PLP) circuit 620, according to one or more embodiments. Compact storage server 600 is substantially similar or configuration and operation to compact storage server 120 in FIGS. 1 and 2, except that compact storage server 600 includes PLP circuit 620. PLP circuit 620 is configured to power memory 205, processor 207, and SSDs 603 and 604 for a short but known time interval, thereby allowing data stored in memory 205 to be copied to a reserved region 605 of SSD 603 or 604 in the event of unexpected power loss. Advantageously, a portion of memory 205 can be employed as a smaller, but much faster mass storage device than SSDs 604 or 604, since DRAM write operations are typically performed orders of magnitude faster than NAND write operations. Thus, processor 207 may cause data received by compact storage server 600 from an external client to be initially stored in memory 205 rather than in SSDs 603 or 604; PLP circuit 620 allows some or all of memory 205 to temporarily function as non-volatile memory, and data stored therein will not be lost in the event of unexpected power loss to compact storage server 600. As shown, PLP circuit 620 includes a management integrated circuit (IC) 621 and a temporary power source 622.

Management IC 621 is configured to monitor an external power source (not shown) and temporary power source 622, and to alert processor 207 of the status of each. Management IC 621 is configured to detect interruption of power from the external power source, to alert processor 207 of the interruption of power (for example via a power loss indicator signal), and to switch temporary power source 622 from an “accept power” mode to a “provide power” mode. Thus, when an interruption of power from the external power source is detected, compact storage server 600 can continue to operate for a finite time, for example a few seconds or minutes, depending on the charge capacity of temporary power source 622. During such a time, processor 207 can copy data stored in memory 205 to reserved region 605 of SSD 603 or 604. Furthermore, upon power restoration from the external power source, processor 207 is configured to copy data stored in reserved region 605 back to memory 205.

Management IC 621 also monitors the status of temporary power source 622, notifying processor 207 when temporary power source 622 has sufficient charge to power processor 207, memory 205, and SSDs 603 and 604 for a minimum target time. Generally, the minimum target time is a time period that is at least as long as a time required for processor 207 to copy data stored in memory 205 to reserved region 605. For example, in an embodiment in which the storage capacity of memory 205 is approximately 1 gigabyte (GB) and the data rate of SSD 603 and 604 is approximately 650 megabytes (MBs) per second, the minimum target time may be up to about two seconds. Thus, when management IC 621 determines that temporary power source 622 has insufficient charge to provide power to processor 207, memory 205, and SSDs 603 and 604 for two seconds, management IC 621 notifies processor 207. In some embodiments, when temporary power source 622 has insufficient charge to power processor 207, memory 205, and SSDs 603 and 604 for the minimum target time, processor 207 does not make memory 205 available for temporarily storing write data. In this way, write data are not stored in temporarily stored in memory 205 that may be lost in the event of power loss.

Temporary power source 622 may be any technically feasible device capable of providing electrical power to processor 207, memory 205, and SSDs 603 and 604 for a finite period of time, as described above. Suitable devices includes rechargeable batteries, dielectric capacitors, and electrochemical capacitors (also referred to as “supercapacitors”). The size, configuration, and power storage capacity of temporary power source 622 depends on a plurality of factors, including power use of SSDs 603 and 604, the data storage capacity of memory 205, the data rate of SSDs 603 and 604, and space available for temporary power source 622. One of skill in the art, upon reading this disclosure herein, can readily determine a suitable size, configuration, and power storage capacity of temporary power source 622 for a particular embodiment of compact storage server 600.

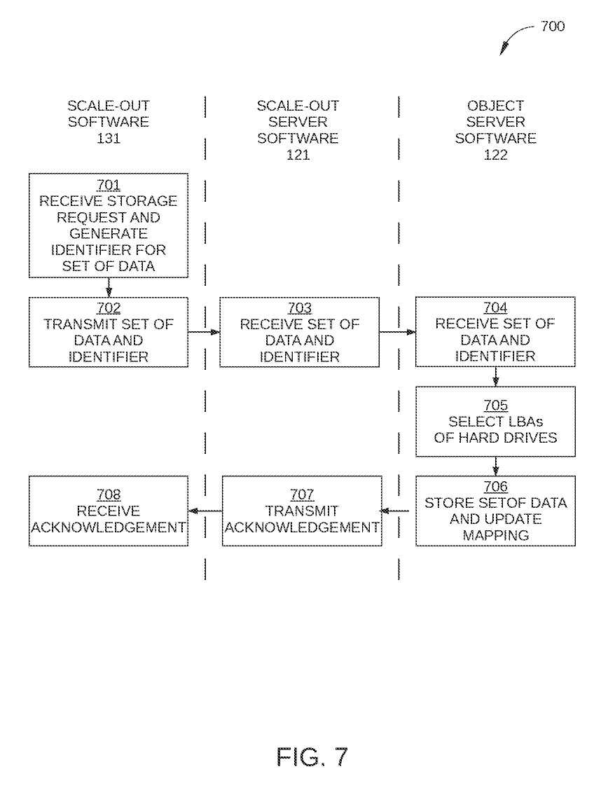

FIG. 7 sets forth a flowchart of method steps carried out by cloud storage system 100 when client 130 makes a data storage request, according to one or more embodiments. Although the method steps are described in conjunction with cloud storage system 100 of FIG. 1, persons skilled in the art will understand that the method in FIG. 7 may also be performed with other types of computing systems.

As shown, a method 700 begins at step 701, where, in response to client 130 receiving a storage request for a set of data, scale-out software 131 generates an identifier associated with the set of data. For example, an end-user of a web-based data storage service may request that client 130 store a particular file or data structure. As noted above, the identifier may be a key or other object-based identifier. In one or more embodiments, scale-out software 131 is configured to determine which of the plurality of compact storage servers 120 of cloud storage system 100 will be the “target” compact storage server 120, i.e., the particular compact storage server 120 that will be requested to store the set of data. In such embodiments, scale-out software 131 may be configured to use information in the identifier as a parameter for calculating the identity of the target compact storage server 120. Furthermore, in such embodiments, scale-out software 131 may generate the identifier using an algorithm that distributes objects between the various compact storage servers 120 of cloud storage system. For example, scale-out software 131 may use a pseudo-random distribution of identifiers among the various compact storage servers 120 to distribute data among currently available compact storage servers 120.

In step 702, scale-out software 131 transmits a data storage command that includes the set of data and the identifier associated therewith to the target compact storage server 120 via network 140. In some embodiments, the data storage command is transmitted to the target compact storage server 120 as an object that includes a sequence of bytes (the set of data) and the identifier. In some embodiments, scale-out software 131 performs step 702 by executing a PUT request, in which the target compact storage server 120 is instructed to store the data set on a mass storage device connected to the target compact storage server 120 via an internal bus. It is noted that each compact storage server 120 of cloud storage system 100 is connected directly to network 140 and consequently is associated with a unique network IP address. Thus, the set of data and identifier are transmitted by scale-out software 131 directly to scale-out server software 121 of the target compact storage server 120; no intervening server or computing device is needed to translate object identification in the request to a specific location, such as to a sequence of logical block addresses of a particular compact storage server 120. In this way, data storage for cloud computing can be scaled.

In step 703, scale-out server software 121 receives the data storage command that includes the set of data and the associated identifier, for example via a PUT request. In response to the received data storage command, scale-out server software 121 transmits the data storage command to object server software 122. It is noted that scale-out server software 121 and object server software 122, as shown in FIG. 2, are both running on processor 207 and reside in memory 205. In step 704, object server software 122 receives the data storage command. In step 705, object server software 122 selects a set of LBAs that are associated with an addressable space of one or both of the hard disk drives of target compact storage server 120 (e.g., HDDs 201 and/or 202 of FIG. 2).

In step 706, object server software 122 stores the set of data received in step 704 in physical locations in one or both of the hard disk drives of the target compact storage server 120 that correspond to the set of LBAs selected in step 705. In addition, object server software 122 stores or updates mapping 250, which associates the selected LBAs with the identifier, so that the set of data can later be retrieved based on the identifier and no specific information regarding the physical locations in which the set of data is stored. Alternatively, in some embodiments, object server software 122 initially stores the set of data received in step 704 in SSD 203 and/or SSD 204, and subsequently stores the set of data received in step 704 in physical locations in one or both of the hard disk drives, for example as a background process. In some embodiments, metadata associated with the set of data and the identifier, for example mapping data indicating the location of the set of data and the identifier in the target compact storage server 120, are stored in a different storage device in the compact storage server 120. For example, in some embodiments, such metadata may be stored in one of SSDs 203 or 204, or in a different HDD in the target compact storage server 120 than the HDD used to store the set of data and the identifier.

In step 707, scale-out server software 121 transmits an acknowledgement that the set of data are in fact stored. It is noted that scale-out server software 121 runs locally on the target compact storage server 120 (e.g., on processor 207). Consequently, scale-out server software 121 is connected to the mass storage device that stores the set of data (e.g., HDDs 201 and/or 202) via an internal bus (e.g., bus 211 of FIG. 2), rather than via a network connection. In some embodiments, scale-out server software 121 may also perform any predetermined replication of the data set, for example by scaleout software 131 sending a peer-to-peer PUT command to a compact storage server 120, causing that server to generate the same PUT command to another compact storage server 120 of cloud storage system 100. In step 708, scale-out software 131 receives the acknowledgement from scale-out server software 121.

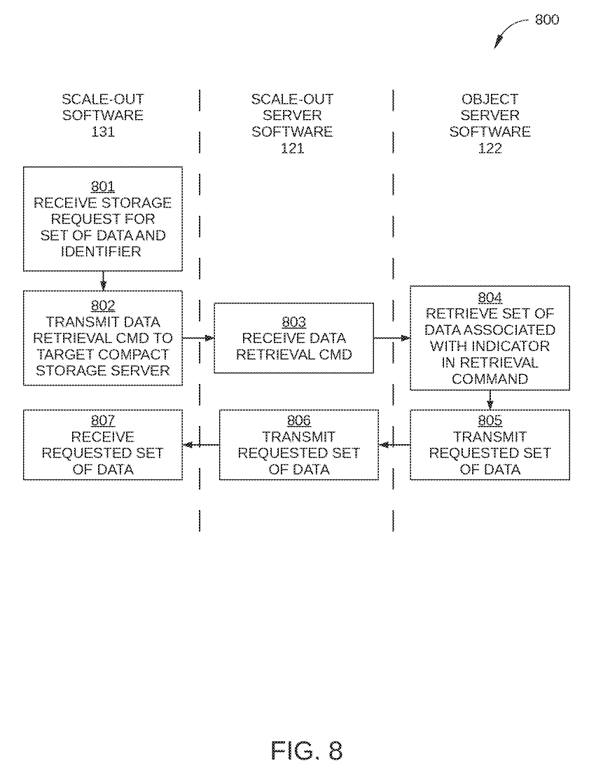

FIG. 8 sets forth a flowchart of method steps carried out by cloud storage system 100 when client 130 makes a data retrieval request, according to one or more embodiments. Although the method steps are described in conjunction with cloud storage system 100 of FIG. 1, persons skilled in the art will understand that the method in FIG. 8 may also be performed with other types of computing systems.

As shown, a method 800 begins at step 801, where scale-out software 131 receives a data retrieval request for a set of data stored in physical locations in HDD 201 or HDD 202 and associated with a particular object. For example, scale-out software 131 may receive a request for the set of data from an end-user of client 130. In step 802, scale-out software 131 transmits a data retrieval command to the target compact storage server 120, where the command includes the identifier associated with the particular set of data requested. In one or more embodiments, scale-out software 131 may include a library or other data structure that allows scale-out software 131 to determine the identifier associated with this particular set of data and which of the plurality of compact storage servers 120 is the storage server that currently stores this particular set of data. In one or more embodiments, scale-out software 131 performs step 802 by executing a GET request, in which scale-out software 131 instructs scale-out server software 121 of the target compact storage server 120 to retrieve the set of data from a mass storage device that is connected to the target compact storage server 120 via an internal bus and stores the requested set of data.

It is noted that each compact storage server 120 of cloud storage system 100 is connected directly to network 140 and consequently is associated with a unique network IP address. Thus, the request transmitted by scale-out software 131 in step 802 for the set of data is transmitted directly to scale-out server software 121 of the target compact storage server 120; no intervening server or computing device is needed to translate object identification to a specific location (e.g., a sequence of logical block addresses).

In step 803, scale-out server software 121 receives the data retrieval command for the data set. As noted above, the data retrieval command includes the identifier associated with the particular set of data requested, for example in the form of a GET command. In response to the data retrieval command, scale-out server software 121 transmits the data retrieval command to object server software 122.

In step 804, in response to the data retrieval command, object server software 122 retrieves or fetches the set of data associated with the identifier included in the request. The set of data is retrieved or fetched from one or more of the mass storage devices connected locally to scale-out server software 121 (e.g., HDDs 201 and/or 202). For example, object server software 122 may determine from mapping 250 a set of LBAs from which to read data, and reads data from the physical locations in the mass storage devices that correspond to the determined set of LBAs.

In step 805, object server software 122 transmits the requested data to scale-out server software 121. In step 806, step scale-out server software 121 returns the requested set of data to the client 130 that transmitted the request to the target compact storage server 120 in step 802. In step 807, scale-out software 131 of the client 130 that transmitted the request in step 802 receives the set of data.

In sum, embodiments described herein provide a compact storage server suitable for use in a cloud storage system. The compact storage server may be configured with two 2.5-inch form factor disk drives, at least one solid-state drive, and a processor, all mounted on a support frame that conforms to a 3.5-inch disk drive form factor specification. Thus, the components of a complete storage server are disposed within an enclosure that occupies a single 3.5-inch disk drive slot of a server rack, thereby freeing additional slots of the server rack for other uses. In addition, storage and retrieval of data in a cloud storage system that includes such compact storage servers is streamlined, since clients can communicate directly with a specific compact storage server for data storage and retrieval.

While the foregoing is directed to embodiments of the present invention, other and further embodiments of the invention may be devised without departing from the basic scope thereof, and the scope thereof is determined by the claims that follow.

We claim:

1. A data storage device comprising:
a support frame that is entirely contained within a region that conforms to a 3.5-inch form-factor disk drive specification;
one or more disk drives mounted on the support frame and entirely contained within the region;
one or more solid-state drives entirely contained within the region and configured with sufficient storage capacity to store a mapping that associates logical block addresses (LBAs) of the one or more disk drives with a plurality of objects stored on the one or more disk drives; and
a processor that is entirely contained within the region and is configured to perform a storage operation based on a mapping stored in the one or more solid-state drives that associates LBAs of the one or more disk drives with a plurality of objects stored on the one or more disk drives.

2. The data storage device of claim 1, wherein the storage operation is performed in response to a read command that includes an identifier associated with an object stored on the one or more disk drives and the processor is further configured to:
receive the read command,
in response to the read command, determine a set of LBAs from which to read data based on the mapping and the identifier,
cause data to be read from physical locations in the one or more disk drives that correspond to the determined set of LBAs, and
return the read data.

3. The data storage device of claim 1, wherein the storage operation is performed in response to a write command that includes a set of data and an identifier associated with the set of data and the processor is further configured to:
receive the write command,
in response to the write command, select a set of LBAs that are associated with an addressable space in the one or more disk drives, and
cause the set of data to be stored in physical locations in at least one of the disk drives that correspond to the selected set of LBAs.

4. The data storage device of claim 3, wherein the processor is configured to cause metadata that are associated with the set of data to be stored in one of the solid-state drives or in a different disk drive than the at least one of the disk drives.

5. The data storage device of claim 3, wherein the one or more disk drives include a first disk drive and a second disk drive and the processor is further configured to cause the set of data to be stored in the physical locations while performing a storage operation in response to an additional write command that includes an additional set of data and an additional identifier.

6. The data storage device of claim 4, wherein receiving the additional write command comprises causing the additional set of data and the additional identifier to be stored in the one or more solid-state drives or in the at least one of the disk drives.

7. The data storage device of claim 3, wherein the processor is further configured to update the mapping after causing the set of data to be stored in physical locations.

8. The data storage device of claim 1, further comprising:
one or more network connectors that are entirely contained within the region and are configured to connect the data storage device to a network,
wherein the storage operation is performed in response to a command generated by a second data storage device connected to the network and is received via the network.

9. The data storage device of claim 8, wherein the data storage device is associated with one or more unique network IP addresses not associated with any other data storage device connected to the network.

10. The data storage device of claim 8, wherein the network has an additional data storage device connected thereto, the additional data storage device comprising:
an additional support frame that is entirely contained within an additional region that conforms to a 3.5-inch form-factor disk drive specification; one or more additional disk drives mounted on the additional support frame and entirely contained within the additional region; one or more additional solid-state drives entirely contained within the additional region and configured with sufficient storage capacity to store an additional mapping that associates LBAs of the one or more additional disk drives with a plurality of objects stored on the one or more additional disk drives; and
a processor that is entirely contained within the region and is configured to perform a storage operation based on a mapping stored in the one or more solid-state drives that associates LBAs of the one or more disk drives with a plurality of objects stored on the one or more disk drives.

11. The data storage device of claim 1, wherein the one or more disk drives include a first disk drive and a second disk drive.

12. The data storage device of claim 1, further comprising a power loss protection circuit coupled to the one or more solid-state drives, the processor, and a memory, wherein the processor is further configured to copy data stored in the memory to a reserved region of the one or more solid-state drives when a power loss indicator signal is received from the power loss protection circuit.

13. A data storage system comprising multiple data storage devices and a network connected to each of the data storage devices, wherein each of the multiple data storage devices comprises:
a support frame that is entirely contained within a region that conforms to a 3.5-inch form-factor disk drive specification;
one or more disk drives mounted on the support frame and entirely contained within the region;
one or more solid-state drives entirely contained within the region and configured with sufficient storage capacity to store a mapping that associates logical block addresses (LBAs) of the one or more disk drives with a plurality of objects stored on the one or more disk drives; and
a processor that is entirely contained within the region and is configured to perform a storage operation based on a mapping stored in the one or more solid-state drives that associates LBAs of the one or more disk drives with a plurality of objects stored on the one or more disk drives.

14. The data storage device of claim 13, wherein the data storage operation is generated by a client and is received via the network.

15. The data storage device of claim 13, wherein the data storage operation is generated by one of the data storage devices and is received via the network.

16. In a data storage system that is connected to a client via a network and includes a server device that conforms to a 3.5-inch form-factor disk drive specification and includes one or more disk drives and one or more solid-state drives, a method of storing data, the method comprising:
performing a data storage operation based on a mapping stored in the one or more solid-state drives that associates LBAs of the one or more disk drives with a plurality of objects stored on the one or more disk drives.

17. The method of claim 16, wherein the data storage operation is performed in response to a read command that includes an identifier associated with an object stored on the one or more disk drives and the method further comprises:
receiving the read command,
in response to the read command, determining a set of LBAs from which to read data based on the mapping and the identifier,
causing data from physical locations in the one or more disk drives that correspond to the determined set of LBAs to be read, and
returning the read data.

18. The method of claim 16, wherein the data storage operation is performed in response to a write command that includes a set of data and an identifier associated with the set of data and the method further comprises:
receiving the write command,
in response to the write command, selecting a set of LBAs that are associated with an addressable space in the one or more disk drives, and
causing the set of data to be stored in physical locations in the one or more disk drives that correspond to the selected set of LBAs.

19. The method of claim 18, further comprising modifying the mapping stored in the one or more solid-state drives to associate the selected set of LBAs with the identifier.

20. The method device of claim 16, wherein the data storage operation is received via the network and is generated by the client or another server device connected to the network.
